(19) United States
(12) Patent Application Publication
(10) Pub. No.: US 2022/0061274 A1
(43) Pub. Date: Mar. 3, 2022

(54) PROTECTED HANDLE FOR COVER

(71) Applicant: BROME BIRD CARE INC., Knowlton (CA)

(72) Inventor: Paul COTE, Knowlton (CA)

(73) Assignee: BROME BIRD CARE INC., Knowlton (CA)

(21) Appl. No.: 17/459,363

(22) Filed: Aug. 27, 2021

Related U.S. Application Data
(60) Provisional application No. 63/071,776, filed on Aug. 28, 2020.

(51) Int. Cl. A01K 39/01

(52) U.S. Cl. CPC A01K 39/0113

(57) ABSTRACT

The present disclosure provides a bird feeder preferably comprised of a cover, a seed container and a seed tray. The cover is further comprised of an annular handle, the handle extended from an underside portion of the cover. The handle is in turn further comprised of locking members that interact with corresponding protrusions on the feed container. The handle is further comprised of a first peripheral edge whereas the cover has a second peripheral edge and the second peripheral edge extends beyond the first peripheral edge.

### CROSS REFERENCE TO RELATED APPLICATION

The present application claims priority to U.S. Provisional Application No. 63/071,776, entitled “Protected Handle for Bird Feeder Cover” filed on Aug. 28, 2020, the contents of which are incorporated herein by reference in their entirety.

### FIELD

The disclosure relates to the field of bird feeding accessories, and more specifically to a handle for bird feeder covers.

### BACKGROUND

Bird feeders have been around for quite some time for bird watchers and animal lovers. Bird feeders such as the ones described herein have a cover, the cover generally utilized to protect seeds from the rain and animals. These covers can be lockable onto the seed container or simply inserted thereover, with the peripheral edge of the cover draping over the circumference of the seed container. With the plurality of birds that hover and fly over the bird feeder, it is known that bird droppings quickly and continuously accumulate on top of the cover.

Unfortunately, bird feeder owners must then handle the cover with multiple bird droppings, or otherwise find gloves to remove and clean the cover. This results in hand contamination.

As such, there is a need for a bird feeder cover that owners can easily remove from the bird feeder, without dirtying their hands by coming into contact with bird droppings.

### SUMMARY

In an aspect, the present disclosure provides a bird feeder comprising: a seed container to contain seeds, the seed container further comprised of apertures to provide access to seeds; a seed tray secured to the seed container; and, a cover releasably secured to the seed container, the cover further comprised of a handle to manipulate and remove the cover from the seed container.

In another aspect, the present disclosure provides an improved cover comprising: a handle to manipulate and remove the cover from a container; and, a plurality of latching members to releasably secure the cover on the container, wherein the handle has a first peripheral edge and the cover has a second peripheral edge and wherein the second peripheral edge extends beyond the first peripheral edge.

### BRIEF DESCRIPTION OF THE DRAWINGS

The following figures serve to illustrate various embodiments of features of the disclosure. These figures are illustrative and are not intended to be limiting.

FIG. 1 is a perspective view of a bird feeder according to an embodiment of the present disclosure;

FIG. 2 is an underside perspective view of a cover of the bird feeder shown in FIG. 1, according to an embodiment of the present disclosure;

FIG. 3 is an underside perspective view of a collar of the bird feeder shown in FIG. 1, according to an embodiment of the present disclosure;

FIG. 4 is an underside perspective view of the cover secured to the collar in an unsecured position, according to an embodiment of the present disclosure;

FIG. 5 is an underside perspective view of the cover secured to the collar in a secured position, according to an embodiment of the present disclosure;

FIG. 6 is a perspective view of a bird feeder according to another embodiment of the present disclosure;

FIG. 7 is an underside perspective view of a cover of the bird feeder shown in FIG. 6, according to another embodiment of the present disclosure;

FIG. 8 is an underside perspective view of a collar of the bird feeder shown in FIG. 6, according to another embodiment of the present disclosure;

FIG. 9 is an underside perspective view of the cover secured to the collar in a secured position of the bird feeder shown in FIG. 6, according to another embodiment of the present disclosure; and,

FIG. 10 is an enlarged perspective cross-sectional view of the cover secured to the collar in the secured position of the bird feeder shown in FIG. 6, according to another embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

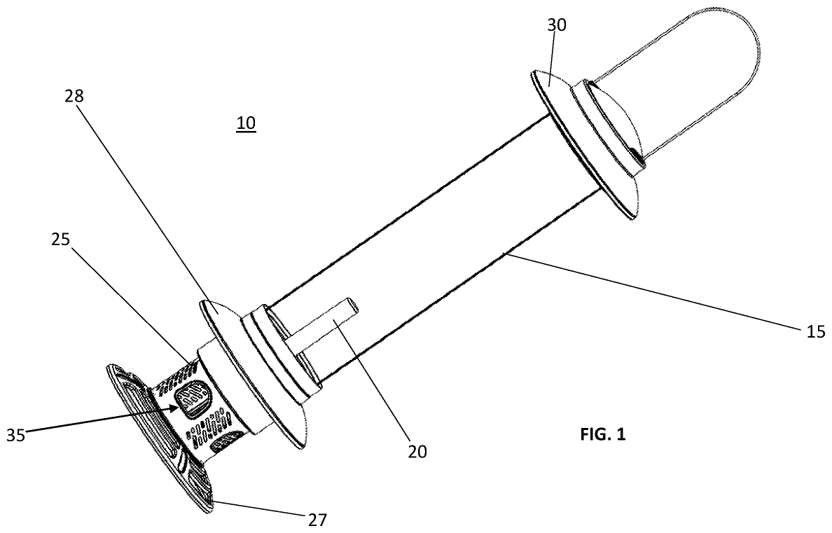

With reference to FIG. 1 and according to an embodiment of the present disclosure, a bird feeder 10 is shown, preferably comprised of a seed container 15, a seed tray 20, a shroud 25 and a cover 30. The seed container 15 has an opening at a top end to receive seeds when the cover 30 has been removed. The seed container 15 is preferably secured to the seed tray 20 by threaded engagement. The seed tray 20 is comprised of at least one aperture (not shown) to access the seeds. The seed tray 20 is also connected to the shroud 25 by means of a nut (not shown) fastened to a threaded plunger (not shown) of the seed tray 20. The shroud 25 protects a lower portion of the seed tray 20 and seed container 15. The shroud 25 is shown connected to a perch 27 and a skirt 28, although a worker skilled in the art would appreciate that the shroud 25, perch 27 and skirt 28 could be formed of a single, integral piece. The shroud 25 is further comprised of apertures 35 that are aligned with the apertures (not shown) of the seed tray 20. During operation of the bird feeder 10, weight on the perch engages the nut (not shown) and threaded plunger (not shown), causing the aperture (not shown) of the seed tray 20 and the aperture 35 of the shroud 25 to become misaligned and therefore prevent access to the seeds. The bird feeder 10 is comprised of a cover 30, the cover 30 able to be releasably secured to a collar (not shown), the collar (not shown) in turn secured to the seed container 15.

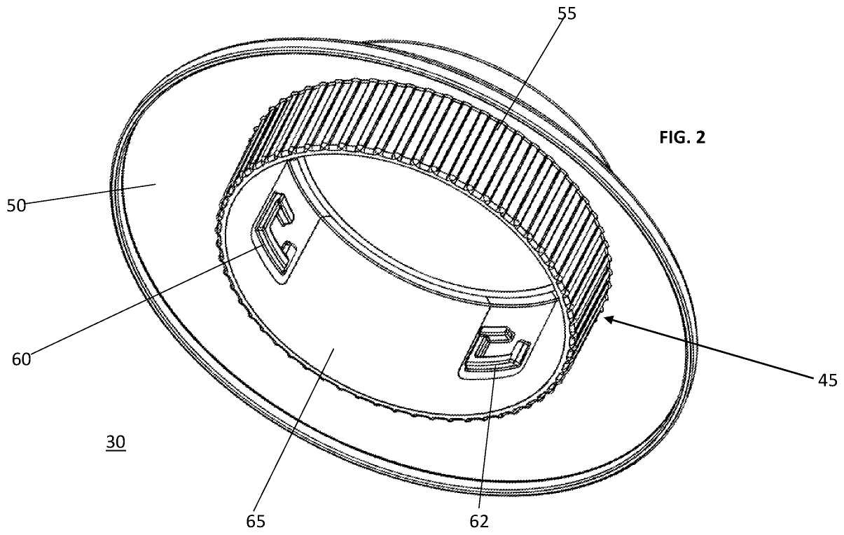

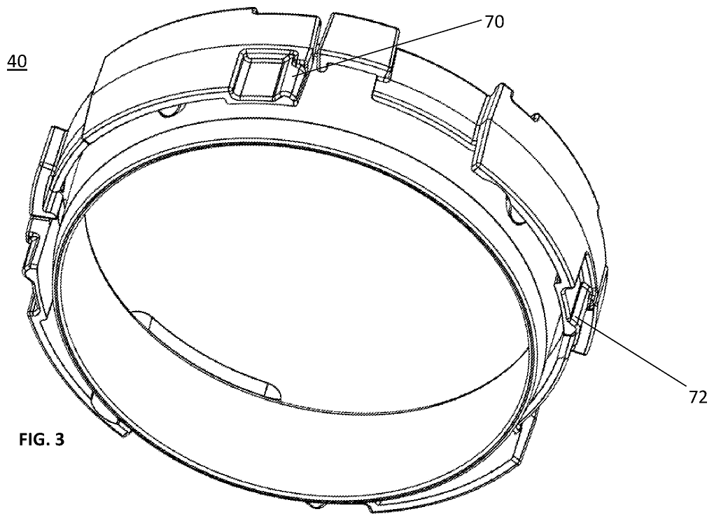

With reference to FIGS. 2 and 3 and according to an embodiment of the present disclosure, the cover 30 and collar 40 are shown, respectively. The cover 30 is further comprised of an annular handle 45 to manipulate and remove the cover 30 from the seed container (not shown). Although the handle 45 is cylindrically shaped, a worker skilled in the art would appreciate that the handle 45 may be triangular, have two or more opposed tabs, or be other shapes as long as the handle 45 can be gripped and manipulated by an operator. Indeed, birds are constantly flying around bird feeders and as such, bird feeder covers are often covered with droppings. It is a problem in the art for bird feeder owners to sanitarily remove the dirty and droppings-covered covers of bird feeders to add seeds to seed containers. The present handle 45 provides an alternative for bird feeder owners, who can grasp and manipulate the handle 45 and remove the cover 30 from the seed container (not shown) without touching the top of the cover 30. The handle 45 extends downwardly and away from an underside 50 of the cover 30. The handle 45 is further comprised of a plurality of outwardly facing longitudinal ribs 55 to better grasp the handle 45. The handle 45 is also further comprised of at least two latching members 60, 62 positioned on an interior surface 65 of the handle 45. The latching members 60, 62, interact with two protrusions 70, 72 of the collar 40 to removably secure or otherwise latch the handle 45 onto the collar 40, which in turn is attached to the feed container (not shown). Indeed, the collar 40 is attached to the feed container (not shown) by means of nipples (not shown) fastened into corresponding holes (not shown) of the seed container (not shown). Although a worker skilled in the art would appreciate that the protrusions 70, 72 are positioned on a collar 45 that is in turn attached the feed container (not shown), such protrusions 70, 72 could similarly be positioned directly on the seed container (not shown) without departing from the scope of the disclosure. A worker skilled in the art would further appreciate that the handle 45 has a first peripheral edge and the cover 30 has a second peripheral edge. As long as the second peripheral edge of the cover 30 extends beyond the first peripheral edge of the handle 45, the handle 45 remains completely hidden and protected by the cover 30 such that bird droppings do not land on the handle 45. As such, an operator is able to sanitarily remove the cover 30 from the seed container (not shown) without coming into contact with bird droppings or other debris or dirt on the cover 30.

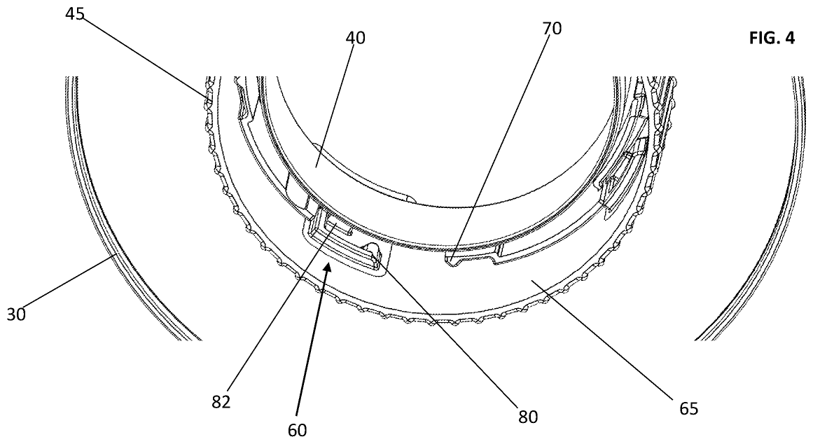

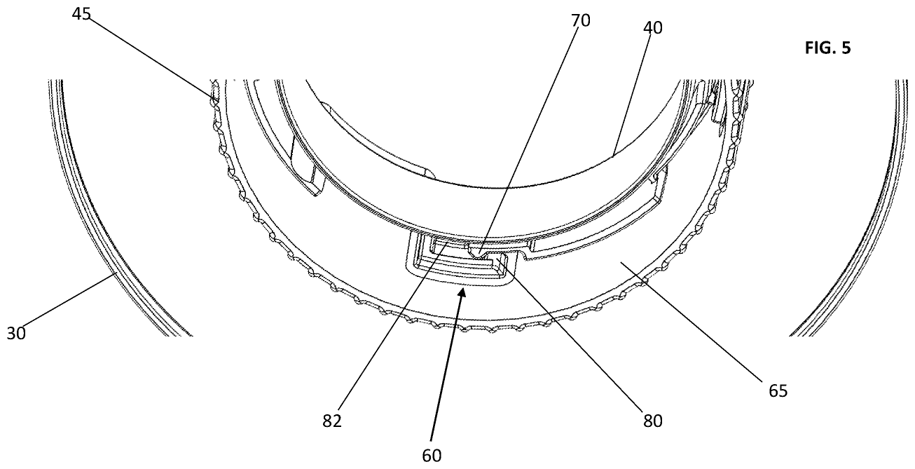

With reference to FIGS. 4 and 5 and according to an embodiment of the present disclosure, the handle 45 of the cover 30 is shown connected to the collar 40 in an unsecured and secured position, respectively. With specific reference to FIG. 4, the cover 30 is positioned on the collar 40 and the protrusion 70 of the collar 40 is positioned adjacent to and nearly flush against the interior surface 65 of the handle 45. With specific reference to FIG. 5, the handle 45 has been rotated clockwise and the protrusion 70 is trapped in between the first and second walls 80, 82 of the member 60. In this secured position, the cover 30 cannot move vertically independently from the collar 40. To release the cover 30 from the collar 40, an operator grasps the handle 45 and rotates the handle 45 counterclockwise. Continued rotation of the handle 45 forces the protrusion 70 over the first wall 80 and into the unsecured position as shown in FIG. 4. At this moment the cover 30 can be separated from the collar 40 and the operator can access the opening (not shown) of the seed container (not shown). Once again, a worker skilled in the art would appreciate that the protrusion 70 could be positioned directly on the feed container (not shown) such that the collar 40 would not be required.

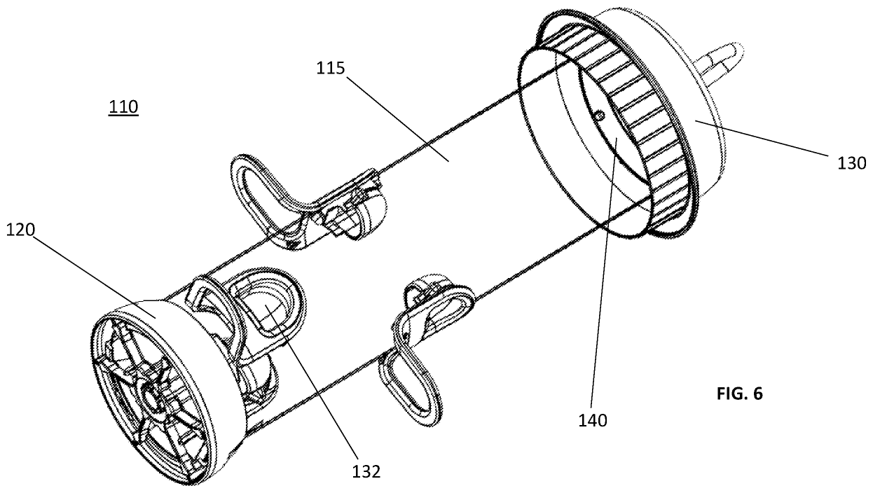

With reference to FIG. 6 and according to an embodiment of the present disclosure, a bird feeder 110 is shown, preferably comprised of a seed container 115, a seed tray 120 and a cover 30. The seed container 115 has an opening at a top end to receive seeds when the cover 130 has been removed. The seed container 115 is secured to the seed tray 120, preferably but not necessarily by threaded engagement. The seed container 115 is comprised of at least one aperture 132 to access the seeds. The cover 130 is able to be releasably secured to a collar 140, the collar 140 in turn secured to the seed container 115.

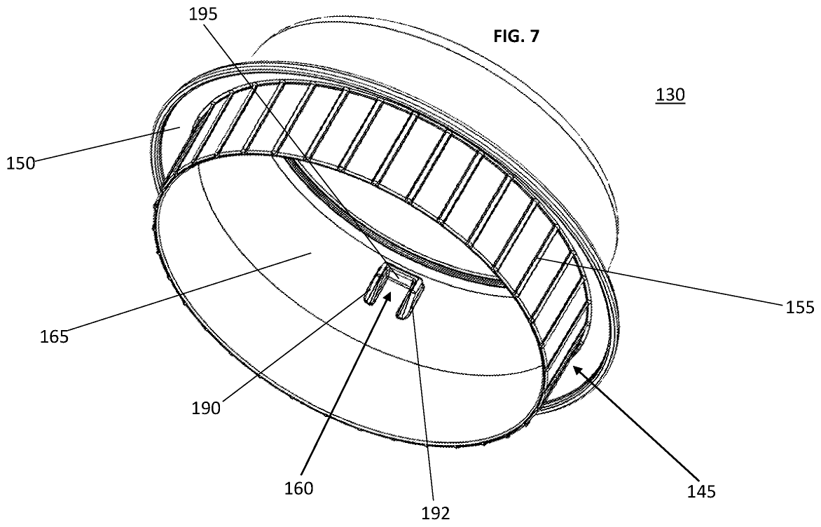

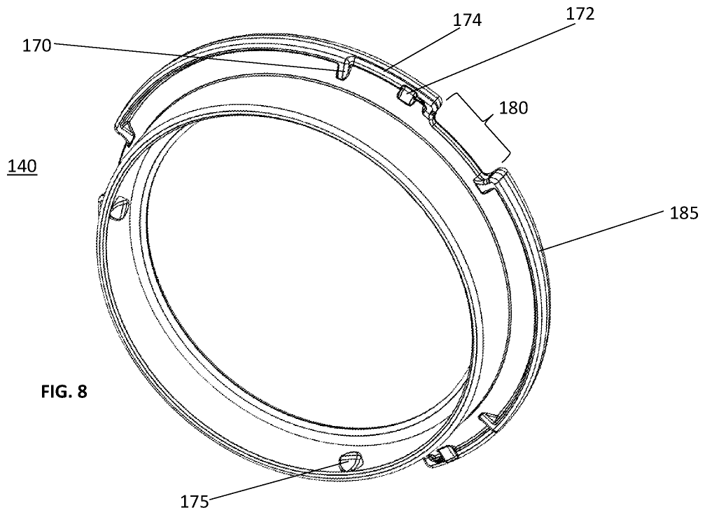

With reference to FIGS. 7 and 8 and according to an embodiment of the present disclosure, the cover 130 and collar 140 are shown in greater detail. The cover 130 is further comprised of an annular handle 145 to manipulate and remove the cover 130 from the seed container (not shown). Although the handle 145 is cylindrically shaped, a worker skilled in the art would appreciate that the handle 145 may be other shapes provided that the handle 145 can be gripped and manipulated by an operator. The handle 145 allows bird feeder owners to grasp and manipulate the handle 145 and remove the cover 130 from the seed container (not shown) without touching the top of the cover 130. The handle 145 extends away from an underside 150 of the cover 130. The handle 145 is further comprised of a plurality of outwardly facing longitudinal ribs 155 to better grasp the handle 145. The handle 145 is also further comprised of at least two latching members 160 positioned on an interior surface 165 of the handle 145. The collar 140 is further comprised of a pair of protrusions 170, 172 separated by a connecting wall 174. The latching members 160 interact with the pairs of protrusions 170, 172 to position and fit the handle 145 onto the collar 140, which in turn is attached to the feed container (not shown). Indeed, to secure the cover 130 over the collar 140, the cover 130 is inserted thereon and rotated until the latching members 160 are aligned and in between each pair of protrusions 170, 172. The cover 130 is then pushed downwardly toward the collar 140 and the latching members 160 fit in between the protrusions 170, 172, which exert pressure thereon. The cover 130 can then no longer be rotated independently from the collar 140 and is secured thereto. The collar 140 is attached to the feed container (not shown) by means of nipples 175 fastened into corresponding holes (not shown) of the seed container (not shown). Although a worker skilled in the art would appreciate that the protrusions 170, 172 are positioned on the collar 145 that is in turn attached the feed container (not shown), such protrusions 170, 172 could similarly be positioned directly on the seed container (not shown) without departing from the scope of the disclosure. A worker skilled in the art would further appreciate that the handle 145 has a peripheral edge and the cover 130 also has a peripheral edge. As long as the second peripheral edge of the cover 130 extends beyond the peripheral edge of the handle 145, the handle 145 remains completely hidden and protected by the cover 130 such that bird droppings do not land on the handle 145. An operator is therefore able to easily and sanitarily remove the cover 130 from the seed container (not shown) without coming into contact with bird droppings or other debris or dirt on the cover 130.

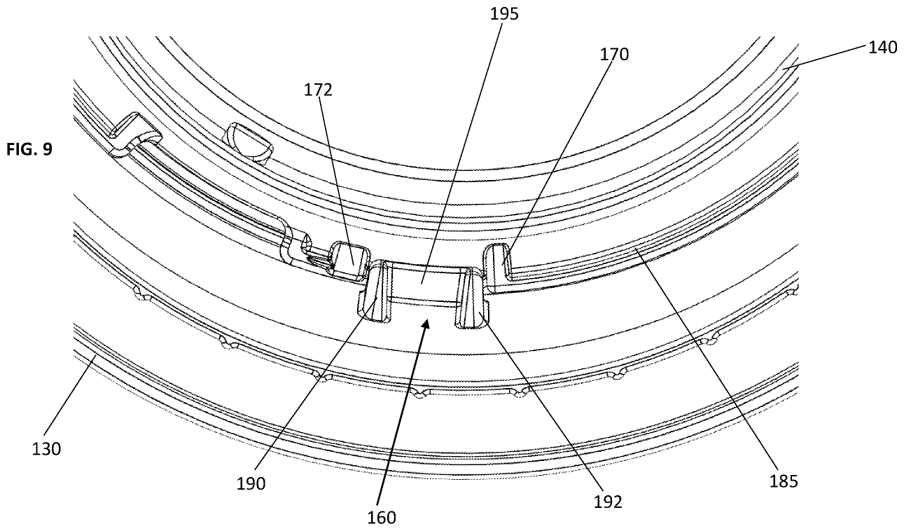

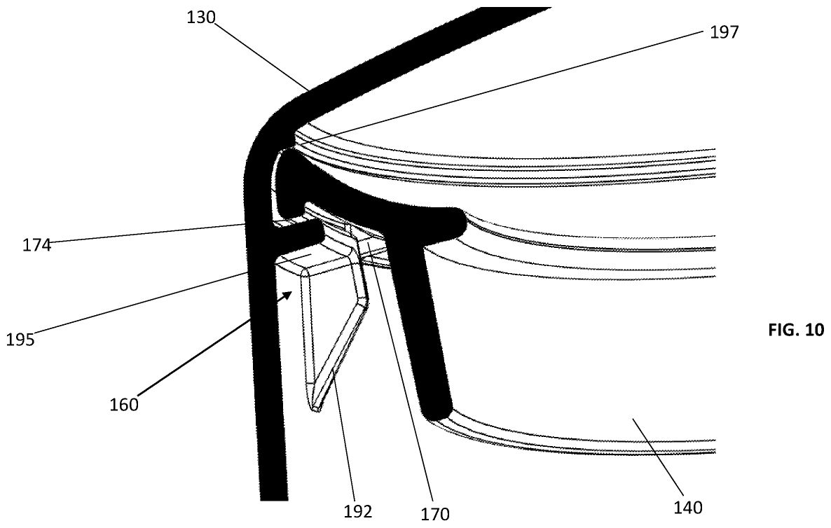

With reference to FIGS. 7, 8, 9 and 10 and according to an embodiment of the present disclosure, an alternate means to connect the latching members 160 and the projections 170, 172 is described and shown in greater detail. The latching members 160 of the cover 130 are aligned with indentations 180 positioned on an outer lip 185 of the collar 140. The cover 130 is then pushed downwardly toward the collar 140 and the latching members 160 fit within the indentations 180. The latching members 160 are comprised of sloping surfaces 190, 192 that facilitate such positioning. The cover 130 is then rotated until the latching members 160 slide over the projection 172 and abut against the projection 170. The latching members 160 are then trapped in between the protrusions 170, 172. As best shown in FIG. 10, the connecting wall 174 abuts against a top segment 195 of the latching members 160 such that the cover 130 cannot be lifted upward and away from the collar 140. The cover 130 is further comprised of an inner lip 197. The inner lip 197 serves to receive the outer lip 185 of the collar 140 when the cover 130 is placed over the collar 140. Further, when the cover 130 is rotated about the collar 140, the outer lip 185 slides along the inner lip 197.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A bird feeder comprising:
a seed container to contain seeds, the seed container further comprised of apertures to provide access to seeds;
a seed tray secured to the seed container; and,
a cover releasably secured to the seed container, the cover further comprised of a handle to manipulate and remove the cover from the seed container.

2. The bird feeder of claim 1 wherein the handle extends downwardly from an underside of the cover.

3. The bird feeder of claim 1 wherein the handle has a first peripheral edge and the cover has a second peripheral edge and wherein the second peripheral edge extends beyond the first peripheral edge.

4. The bird feeder of claim 1 wherein the handle is further comprised of a plurality of vertical ribs.

5. The bird feeder of claim 1 wherein the handle is further comprised of latching members to position and secure the cover to the seed container.

6. The bird feeder of claim 5 further comprised of a collar secured to the seed container, the collar comprising:
a plurality of indentations to receive the latching members; and,
a plurality of protrusions to lock the latching members.

7. An improved cover comprising:
a handle to manipulate and remove the cover from a container; and,
a plurality of latching members to releasably secure the cover on the container,
wherein the handle has a first peripheral edge and the cover has a second peripheral edge and wherein the second peripheral edge extends beyond the first peripheral edge.

8. The improved cover of claim 7 wherein the plurality of latching members are further comprised of two sloping surfaces separated by a top segment.

9. The improved cover of claim 8 wherein the container is further comprised of two protrusions configured to receive the plurality of latching members.

10. The improved cover of claim 7 wherein the plurality of latching members are further comprised of first and second walls, the first and second walls to receive and trap protrusions of the container.

11. The improved cover of claim 7 further comprised of a circumferential inner lip.
